(19) United States
(12) Patent Application Publication
(10) Pub. No.: US 2025/0121719 A1
(43) Pub. Date: Apr. 17, 2025

(54) ELECTRIC VEHICLE CHARGING STATIONS AND RELATED METHODS

(71) Applicant: Aclara Technologies LLC, St. Louis, MO (US)

(72) Inventors: Jonathan Paul Day, Torrington, CT (US); James Eric Lambert, Dover, NH (US); Joseph Dennis Glazer, Bronxville, NY (US); Robert James Snell, Rochester, NH (US); Ryan James Nelson, Hooksett, NH (US); John Patrick Nesheim, Epsom, NH (US); Douglas A Marsden, Marblehead, MA (US); Matthew Gael Desrochers, Somerville, MA (US); Michael T McDuffee, Gloucester, MA (US); Aidan Rosario, Somerville, MA (US)

(21) Appl. No.: 18/917,795

(22) Filed: Oct. 16, 2024

Related U.S. Application Data
(60) Provisional application No. 63/590,690, filed on Oct. 16, 2023.

(51) Int. Cl. B60L 53/30; B60L 53/16; B60L 53/18; H02J 7/00

(52) U.S. Cl. CPC B60L 53/30; B60L 53/16; B60L 53/18; H02J 7/0042

(57) ABSTRACT

Electric vehicle supply equipment (EVSE) and related methods are provided. The EVSE can include a housing and charging cable. The EVSE can also include a charge coupler coupled to the charge cable and configured to supply power to an electric vehicle.

### RELATED APPLICATION

The presently disclosed subject matter claims the benefit of U.S. Provisional Patent Application Ser. No. 63/590,690, filed Oct. 16, 2023, the disclosure of which is incorporated herein by reference in its entirety.

### TECHNICAL FIELD

The present disclosure relates to a charging station, or electric vehicle supply equipment, for an electric vehicle.

### BACKGROUND

The charging station supplies electrical power to recharge an electric vehicle.

### SUMMARY

Aspects described herein relate generally to the structure of the electric vehicle supply equipment.

In one aspect, the disclosure provides an electric vehicle supply equipment (EVSE) including a housing, a charge cable, a charge coupler coupled to the charge cable and configured to supply power to an electric vehicle, and a charge coupler holster. The charge holster is configured to receive the charge coupler for storage. The charge coupler holster is formed as a separate piece from the housing and configured to be coupled to the housing to provide modularity.

In another aspect the disclosure provides a method of manufacturing an electric vehicle supply equipment (EVSE). The method includes providing an EVSE housing configured to receive a charge coupler holster selectable from a plurality of charge coupler holsters, selecting one of the plurality of charge coupler holsters to mate with the housing, coupling the selected one of the plurality of charge coupler holsters to the housing, and installing a corresponding charge coupler to the EVSE.

In another aspect, the disclosure provides an electric vehicle supply equipment (EVSE). The EVSE includes a mounting bracket configured to be coupled to a mounting surface, the mounting bracket including a first portion and a second portion. The EVSE also includes a housing configured to be coupled to the first portion of the mounting bracket, a charge cable, a charge coupler coupled to the charge cable and configured to supply power to an electric vehicle, and a cable holder configured to support the charge cable coiled thereon. The cable holder is configured to be coupled to the second portion of the mounting bracket. The second portion of the mounting bracket is different from the first portion of the mounting bracket to which the housing is couplable.

In yet another aspect, the disclosure provides an electric vehicle supply equipment (EVSE). The EVSE includes a housing including at least one planar external surface portion and a sub-flush surface recessed from the at least one planar external surface portion. The at least one planar external surface portion immediately surrounds the sub-flush surface. The EVSE also includes a charge coupler configured to supply power to an electric vehicle, and a user interface including at least one actuator disposed in the sub-flush surface.

In yet another aspect, the disclosure provides an electric vehicle supply equipment (EVSE). The EVSE includes a housing defining a main component cavity configured to house at least one circuit board, the housing further defining a separate internal cavity. The EVSE also includes a charge coupler configured to supply power to an electric vehicle. Further, the EVSE includes an internal antenna and an external coupler configured to communicate with the internal antenna disposed in the separate internal cavity such that the external coupler is air-gapped from the main component cavity.

Other aspects of the disclosure will become apparent by consideration of the detailed description and accompanying drawings.

### BRIEF DESCRIPTION OF THE DRAWINGS

FIG. 1 is a schematic diagram illustrating an example electric vehicle supply equipment (EVSE) charging an electric vehicle according to some implementations.

FIG. 2 is a front view of an example EVSE according to some implementations.

FIG. 3 is a side view of the EVSE of FIG. 2.

FIG. 4 is a perspective view of the EVSE of FIG. 2.

FIG. 5 is an exploded view of the EVSE of FIG. 2.

FIG. 6 is an enlarged cutout view of a charge coupler holster of the EVSE of FIG. 2.

FIG. 7A is a front view of one example of the charge coupler holster of the EVSE of FIG. 2.

FIG. 7B is a front view of another example of a charge coupler holster of the EVSE of FIG. 2.

FIG. 8 is a perspective view of the EVSE of FIG. 2 shown with the front cover portion open.

FIG. 9 is a flow chart illustrating a method of manufacturing the EVSE of FIG. 2, according to some implementations.

FIG. 10 is a flow chart illustrating a method of installing the EVSE of FIG. 2, according to some implementations.

FIG. 11 is a cross-sectional side view of a portion of the EVSE of FIG. 2.

FIG. 12 is a front-top perspective view of another embodiment of an example EVSE according to some implementations of the present subject matter.

FIG. 13 is a top plan view of the EVSE of FIG. 12.

FIGS. 14A and 14B are opposing side views of the EVSE of FIG. 12.

FIG. 15 is a perspective view of the EVSE of FIG. 12.

FIG. 16 is an exploded rear view of an embodiment of a housing of the EVSE of FIG. 12.

FIG. 17 is a rear view of the EVSE of FIG. 12.

FIG. 18 is a perspective view of an embodiment of a mounting bracket of the EVSE of FIG. 12.

FIG. 19 is a cross-sectional view of an embodiment of a connection between a mounting bracket and a housing of the EVSE of FIG. 12.

FIG. 20 is a perspective view of the EVSE of FIG. 12 shown with a front cover portion open.

FIG. 21 is a perspective view of a rear cover portion of a housing of the EVSE of FIG. 12.

FIG. 22 is a perspective view of a portion of a rear cover portion of a housing of the EVSE of FIG. 12.

FIG. 23 is a perspective view of a a front cover portion of a housing of the EVSE of FIG. 12.

Repeat use of reference characters in the present specification and drawings is intended to represent the same or analogous features or elements of the present subject matter.

### DETAILED DESCRIPTION

One or more examples, implementations, aspects, and features are described and illustrated in the following description and accompanying drawings. These examples are not limited to the specific details provided herein and may be modified in various ways. Other examples and implementations may exist that are not described herein. For instance, a device or structure that is “configured” in a certain way is configured in at least that way but may also be configured in ways that are not listed. Some examples described herein may include one or more electronic processors configured to perform the described functionality by executing instructions stored in non-transitory, computer-readable medium. Similarly, implementations described herein may be implemented as non-transitory, computer-readable medium storing instructions executable by one or more electronic processors to perform the described functionality. As used in the present application, “non-transitory computer-readable medium” comprises all computer-readable media but does not include a transitory, propagating signal. Accordingly, non-transitory computer-readable medium may include, for example, a hard disk, a CD-ROM, an optical storage device, a magnetic storage device, ROM (Read Only Memory), RAM (Random Access Memory), register memory, a processor cache, other memory and storage devices, or combinations thereof.

The phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. In addition, electronic communications and notifications may be performed using wired connections, wireless connections, or a combination thereof and may be transmitted directly or through one or more intermediary devices over various types of networks, communication channels, and connections. Relational terms, for example, first and second, top and bottom, and the like may be used herein solely to distinguish one entity or action from another entity or action without necessarily requiring or implying any actual such relationship or order between such entities or actions. Implementations or portions of an implementation can be combined with other implementations or portions of other implementations to create yet further implementations, whether or not they are specifically illustrated or described.

### Additional Disclaimers and Definitions

It should also be understood that although certain drawings illustrate hardware and software located within particular devices, these depictions are for illustrative purposes only. In some implementations, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

In some instances, method steps are conducted in an order that is different from the order described. Additionally, in some instances, rather than occurring concurrently, some method steps may instead occur simultaneously.

As used herein, the term a “plurality” means two or more.

As used herein, the terms such as “include,” “including,” “contain,” “containing,” “having,” and the like mean “comprising.” The present disclosure also contemplates other embodiments “comprising,” “consisting of,” and “consisting essentially of,” the embodiments or elements presented herein, whether explicitly set forth or not.

As used herein, the term “a,” “an,” “the” and similar terms used in the context of the disclosure (especially in the context of the claims) are to be construed to cover both the singular and plural unless otherwise indicated herein or clearly contradicted by the context. In addition, “a,” “an,” or “the” means “one or more” unless otherwise specified.

As used herein, the term “or” can be conjunctive or disjunctive.

As used herein, the term “substantially” means to a great or significant extent, but not completely.

As used herein, the term “about” or “approximately” as applied to one or more values of interest, refers to a value that is similar to a stated reference value, or within an acceptable error range for the particular value as determined by one of ordinary skill in the art, which will depend in part on how the value is measured or determined, such as the limitations of the measurement system. In one aspect, the term “about” refers to any values, including both integers and fractional components that are within a variation of up to ±10% of the value modified by the term “about.” Alternatively, “about” can mean within 3 or more standard deviations, per the practice in the art. Alternatively, such as with respect to biological systems or processes, the term “about” can mean within an order of magnitude, in some embodiments within 5-fold, and in some embodiments within 2-fold, of a value. As used herein, the symbol “˜” means “about” or “approximately.”

The terms “air-gapped separation,” “air-gapped,” or the like as used herein means any material, medium, substance, or space that separates two electrically conductive components, or conductors, such as the internal antenna and the antenna coupler, or external coupler referenced herein, that permits electromagnetic transfer of signals between the components with limited interference of the signals with examples being galvanic isolation and di-electric break configurations.

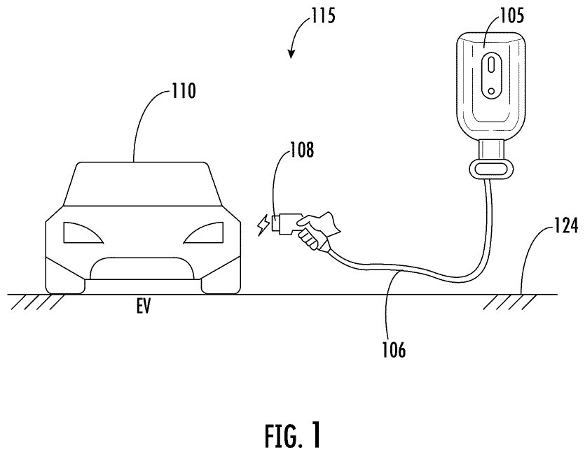

FIG. 1 schematically illustrates an example electric vehicle supply equipment (EVSE) 105 and an electric vehicle 110 (for example, a plug-in electric vehicle or a plug-in hybrid electric vehicle). The EVSE 105 is configured to supply power to the electric vehicle 110 via a charge cable 106 and a charge coupler 108. The charge coupler 108 may be, for example, a SAE J1772 charging connector, an IEC 61851 charging connector, an IEC 62196 charging connector, a Combined Charging Standard (CCS)-type charging connector, a North American Charging Standard (NACS) charging connector, or other charging connectors. In some instances, multiple electric vehicles 110 are connected to and receive power from the EVSE 105. The EVSE 105 is electrically connected to an electrical grid, such as utility or a load center. The EVSE 105 also includes advanced metering infrastructure (AMI) communications and ANSI certified metrology to measure electricity consumption at an accuracy of 0.5% or better. AMI communications offer secure and reliable communications via radio frequency, cellular, powerline carrier, Wi-Fi, and/or other similar long-distance communication mediums with the potential for other communication mediums as they become available. Other aspects and details of the charging system for the EVSE 105 are disclosed in U.S. patent application Ser. No. 18/137,764, filed on Apr. 21, 2023, the entire contents of which are hereby incorporated by reference herein.

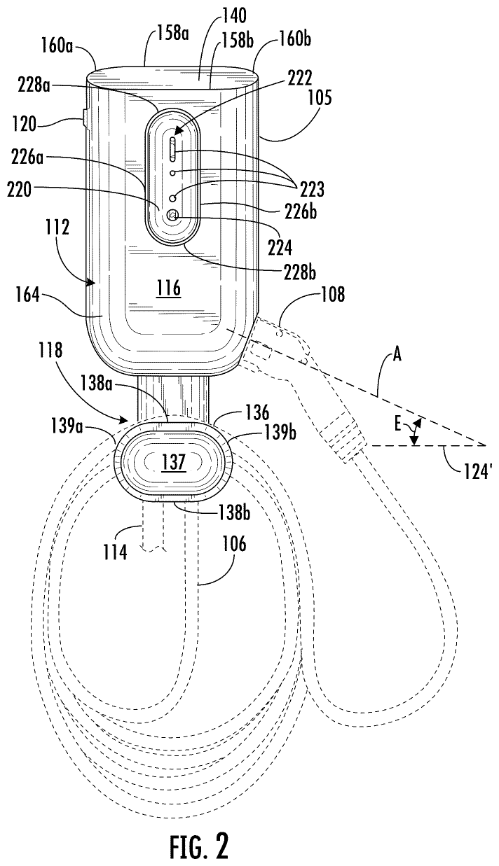

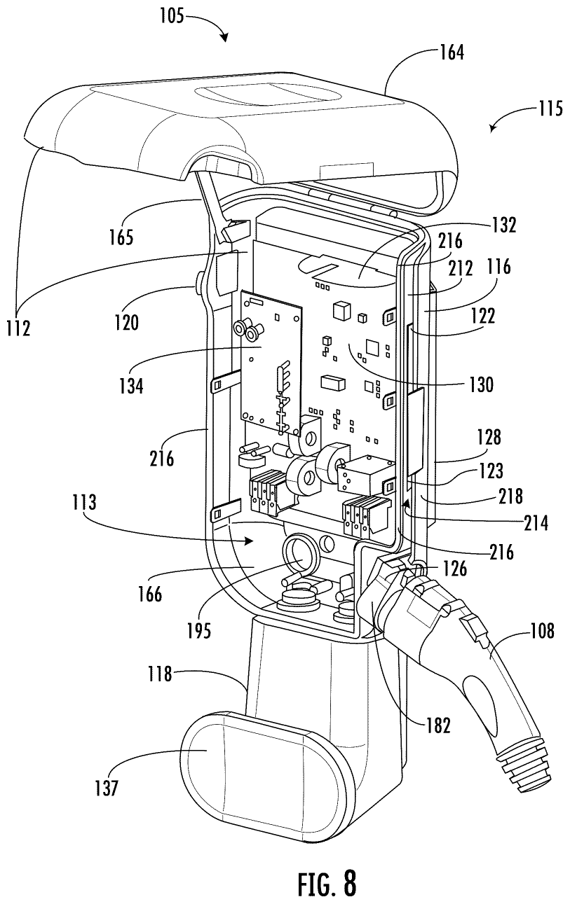

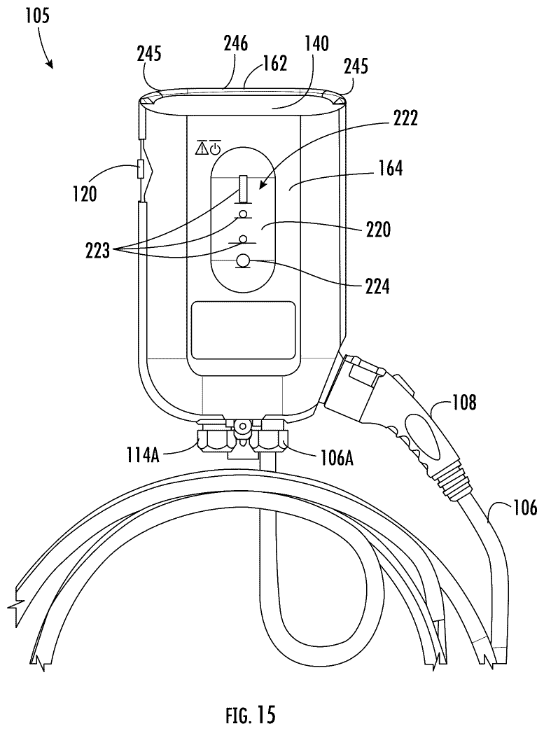

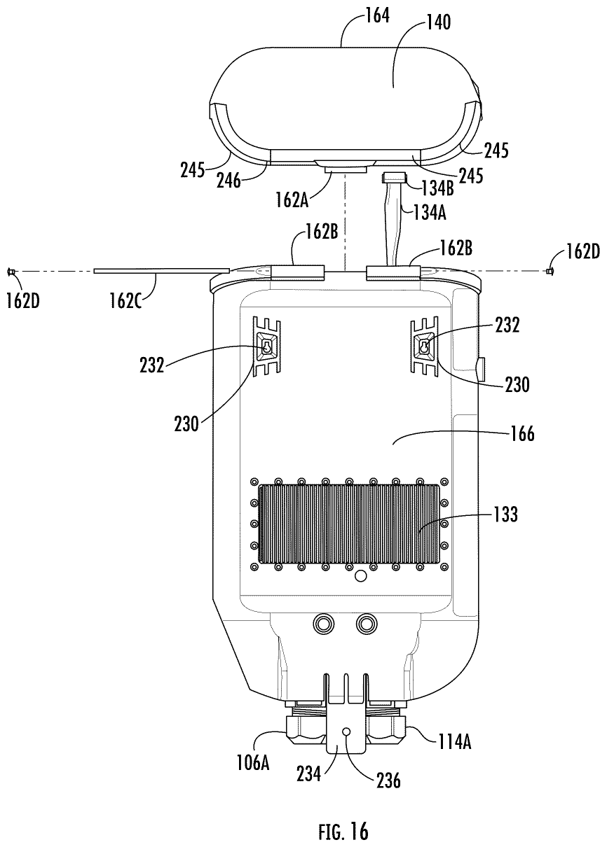

FIG. 2 illustrates one example implementation of the EVSE 105 including a housing 112, which defines a main component cavity 113 (FIG. 8) and houses electrical components (some of which may be described in greater detail below) of the EVSE 105 to protect the electrical components from the elements in the external environment 115 (see FIG. 1). Some or all of the electrical components are disposed in the main component cavity 113. The housing 112 generally defines an external surface 116 configured to be exposed to the external environment 115 in which the electric vehicle 110 is charged. An inlet power cord 114 extends into the housing 112 and is configured to supply electrical power to the EVSE 105 from the electrical grid. The charge cable 106 extends from the housing 112, and the charge coupler 108 is disposed at a distal end of the charge cable 106 to supply electrical power to the electric vehicle 110. A charge coupler cable holder escutcheon 118 (which may be referred to herein as a cable holder 118 for simplicity) is configured to support the charge cable 106 coiled therearound for storage as illustrated in FIG. 2. The inlet power cord 114 and the charge cable 106 can be connected to the EVSE 105 through a power cord connector 114A and a charge cable connector 106A, respectively, as shown in FIGS. 15 and 16. In other embodiments, the inlet power cord 114 and the charge cable 106 can be connected at other locations as needed or desired. For example, a rear portion of the rear cover portion 166 of the housing 112 can include a punch-out 195 that permits the connection of the inlet power cord 114 from the rear of the housing 112.

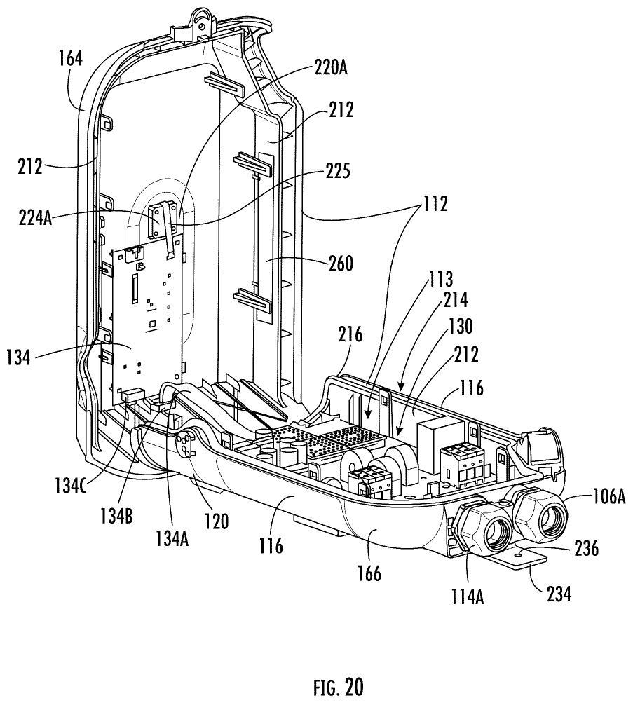

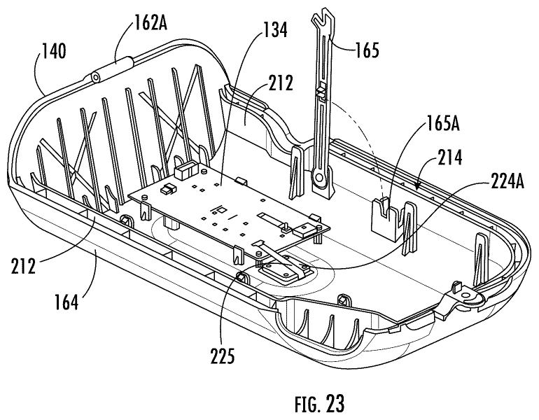

The electrical components of the EVSE 105 may include at least one circuit board. As one example, the electrical components of the EVSE 105 may include an EVSE module 130, an AMI module 132, and a user interface module 134 (FIG. 8). Each of the EVSE module 130, the AMI module 132, and the user interface module 134 may include a respective circuit board, memory, and/or processor configured to provide functionality (e.g., logic, algorithms, programming, etc.) to the EVSE 105. Each of said electrical components may be housed within the housing 112 and may be coupled to any portion of the housing 112. In some embodiments, the user interface module 130 can be secured to the front cover portion 164 of the housing 112 as shown in FIGS. 20 and 23 and explained in greater detail below. More specifically, each of said electrical components may be housed within the main component cavity 113.

The EVSE 105 may also include an optical port 120 and an internal antenna 122. The optical port 120 allows an operator or technician of the EVSE 105 to access software and memory associated with the EVSE 105. For example, an external device may connect to the EVSE 105 via a wireless or physical connection using the optical port 120. As one example, the optical port 120 may be accessed via a USB device that magnetically connects to the optical port 120. As another example, an external device magnetically connects to the optical port 120 and communicates wirelessly with the EVSE 105, allowing bidirectional communication between the EVSE 105 and, for example, a computer used by a utility technician. In some implementations, the optical port 120 is configured as a D-ring. The antenna 122 allows the EVSE 105 to communicate wirelessly over a communication network, such as with the utility over the AMI network.

### Downward Slope on Top of Clamshell Housing

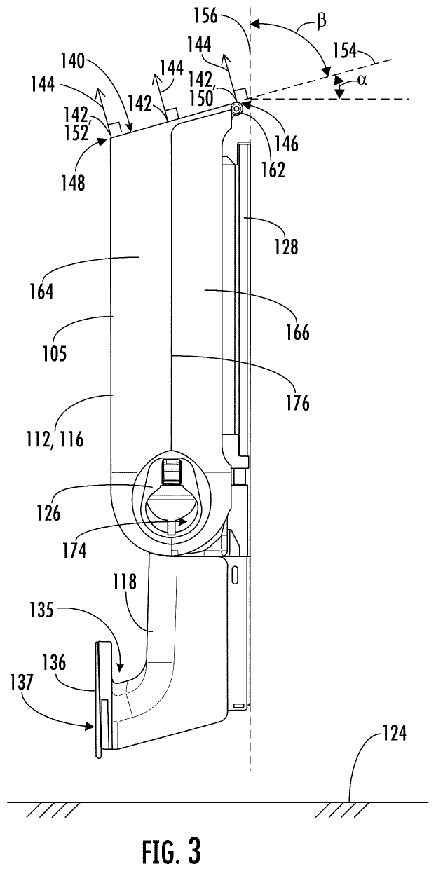

The housing 112 includes a top surface 140. The top surface 140 is considered to be a portion of the housing 112 that faces away from a horizontal reference plane 124 (see FIG. 1) when the EVSE 105 is mounted as suggested by the accompanying mounting hardware and with any symbols, indicia, etc., on the housing 112 being oriented right-way-up as would be understood by one of ordinary skill in the art. The horizontal reference plane 124 is understood to be defined in a plane perpendicular to the direction of gravity, e.g., by the ground, floor, or other support surface. The top surface 140 may be defined as the surface of the housing 112 that is generally opposite the cable holder 118. The top surface 140 may be defined by a set of surface points 142 each defining a normal vector 144 pointing in a direction away from the cable holder 118, or away from a horizontal reference plane 124 to not intersect the horizontal reference plane 124 and not pointing in a direction parallel to the horizontal reference plane 124 as shown in FIG. 3. The top surface 140 may be planar, curved, irregular, etc. The top surface 140 is a continuous surface including all of the surface points 142 of the housing that face away from the horizontal reference plane 124. The top surface 140 is generally entirely sloped, meaning the top surface 140 includes no appreciable horizontal surface (i.e., no appreciable surface parallel to the horizontal reference plane 124). The top surface 140 is sloped from an upper end 146 to a front cover portion 164. The upper end 146 is defined by one of the uppermost 150 of the surface points 142, with “uppermost” meaning farthest of all the surface points 142 from the cable holder 118 or from the horizontal reference plane 124. The lower end 148 is defined by one of the lowermost 152 of the surface points 142, with “lowermost” meaning closest of all the surface points 142 to the cable holder 118 or to the horizontal reference plane 124. A line 154 is defined between the one of the uppermost 150 of the surface points 142 and the one of the lowermost 152 of the surface points 142. An angle α is defined between the line 154 and the horizontal reference plane 142 and generally represents the slope of the top surface 140. The angle α is between 15° and 75°, or more specifically between 15° and 45°, or more specifically between 15° and 35°, or more specifically between 15° and 25°, or more specifically between 15° and 20°. “Between A and B” as used herein is meant to include A, B, and everything in between A and B. In the illustrated implementation, the angle α is about 15° (with “about” meaning “+/−2 degrees”). In the illustrated implementation, the top surface 140 is generally planar; however, in other implementations, the top surface 140 may have a curve or curves, facets, irregularities, etc. “Generally planar” means having the appearance of being planar or almost planar (e.g., but for ridges, grooves, or other minor variations in the surface) to the naked eye of one of ordinary skill in the art using ordinary reasonable judgement.

The line 154 may also be referenced relative to a vertical mounting plane 156 of the EVSE 105. The vertical mounting plane 156 is defined by the mounting bracket 128 (which will be described in greater detail below) as the plane in which the EVSE 105 is mounted, e.g., to a wall, post, or other vertical support structure. As is understood by one of ordinary skill in the art, an angle β defined between the line 154 and the vertical mounting plane 156 is complimentary to the angle α, i.e., angle α+angle β=90 degrees. As such, the angle β is between 15° and 75°, or more specifically between 45° and 75°, or more specifically between 55° and 75°, or more specifically between 65° and 75°, or more specifically between 70° and 75°. “Between A and B” as used herein is meant to include A, B, and everything in between A and B. In the illustrated implementation, the angle β is about 75° (with “about” meaning “+/−2 degrees”).

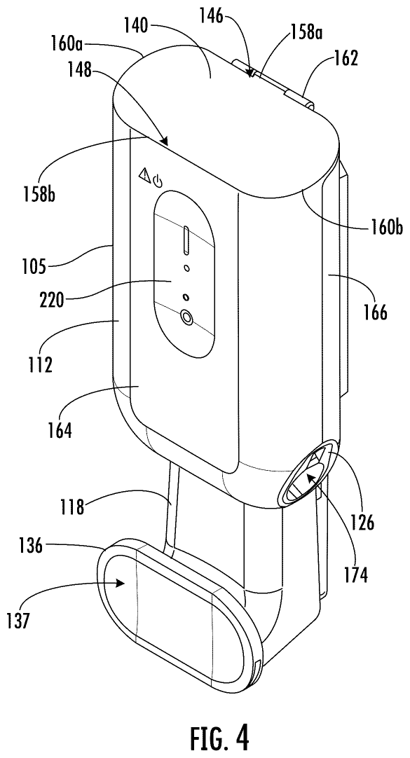

The top surface 140 may have a generally racetrack-like shape, or pill-shape, defined by two opposing generally parallel linear edges 158a, 158b and two opposing curved edges 160a, 160b. “Generally parallel linear edges” herein means having the appearance of being parallel and being linear or mostly linear, e.g., with only deviations that are small relative to the overall extent of the edge. For example, as can be seen in the illustrated implementation (e.g., with reference to FIG. 4), the first parallel linear edge 158a is not perfectly linear in order to accommodate a hinge 162 along the first parallel linear edge 158a but is still generally linear and generally parallel to the second parallel linear edge 158b. The two opposing curved edges 160a, 160b may each (individually) have any convex curved shape (convex with respect to the external environment of the EVSE 105). In the illustrated implementation, the two opposing curved edges 160a, 160b may each (individually) be defined by an arc, or more specifically a semi-circle. In other implementations, the two opposing curved edges 160a, 160b may each have a semi-oval shape. The two opposing curved edges 160a, 160b can be mirror images of each other. The two opposing generally parallel linear edges 158a, 158b can be also mirror images of each other.

The sloped top surface 140 discourages the operator from stowing the charge coupler and/or the charge cable and/or other objects on the top surface 140 of the housing 112 that may interfere with the antenna, or AMI transceiver operations. This improves wireless transceiver range.

The housing 112 has a clamshell style construction including two portions joined together at a clamshell joint: a front cover portion 164 and a rear cover portion 166. The front cover portion 164 includes the top surface 140. The front cover portion 164 is hinged, by way of the hinge 162 relative to the rear cover portion 166 (as shown in FIG. 8). (Thus, the front cover portion 164 may also be referred to as a “hinged” cover portion, or a “movable” cover portion, and the rear cover portion 166 may also be referred to as a “stationary” cover portion, or a “base” cover portion.) The hinge 162 may be a barrel-style hinge with hinge pins, as is well understood in the art, or any other type of suitable hinge. A linkage 165, for example, a prop arm, may be coupled between the front cover portion 164 and the rear cover portion 166 and configured to hold the front cover portion 164 open during servicing. During normal operation, while the front cover portion 164 pivots about the hinge 162, the rear cover portion 166 remains stationary. The front cover portion 164 opens upwards during both field installation and serviceability by authorized utility personnel. The sloped top surface 140 being part of the hinged front cover portion 164 means the front cover portion 164 has no horizontal support surface, which keeps the front cover portion 164 free of objects that may inhibit the serviceperson from being able to open the front cover portion 164.

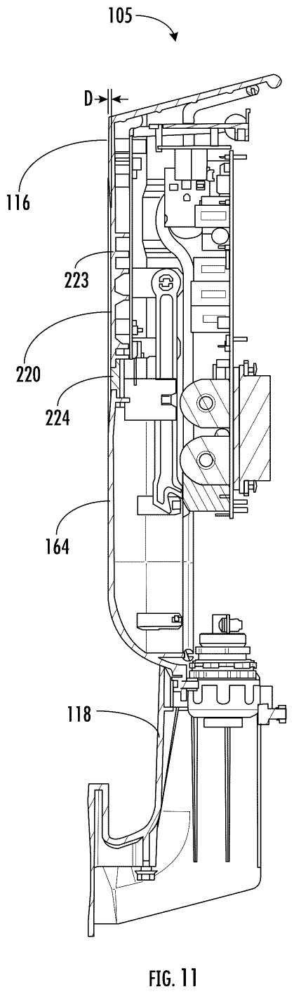

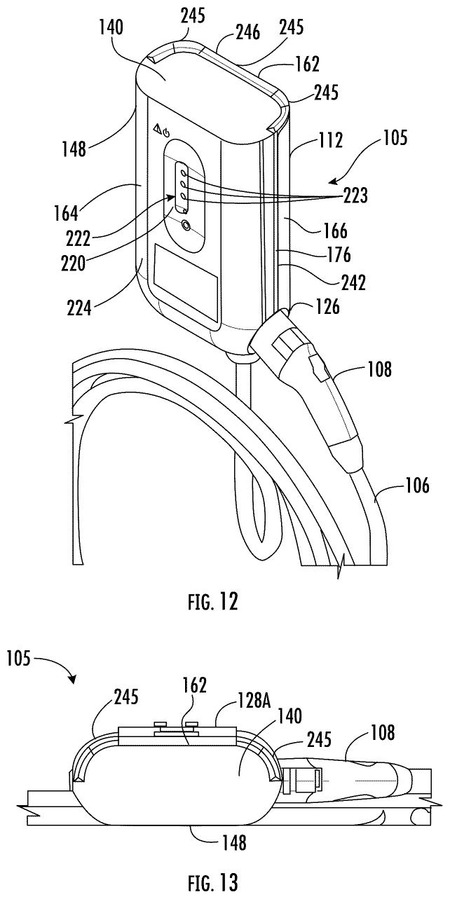

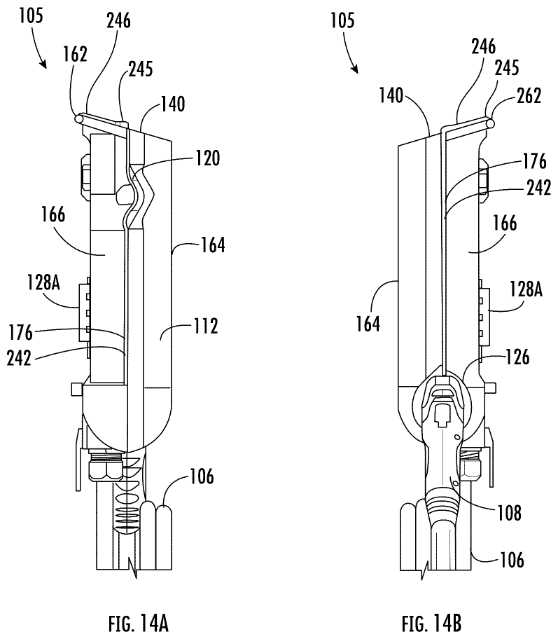

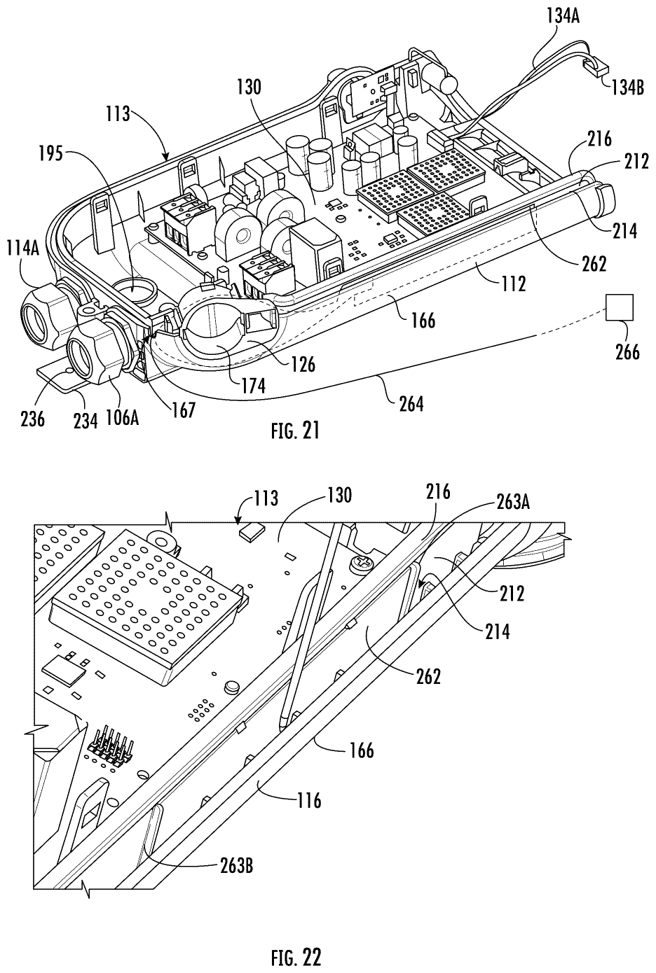

As shown in FIGS. 12-23, a similar EVSE 105 is shown with a housing 112 having a clamshell style construction including a front cover portion 164 and a rear cover portion 166 that are hinged together by a hinge 162. The rear cover portion 166 can include a power cord connector 114A and a charger cable connector 106A and can form at least a portion of the main cavity 113 in which circuit module 130 resides. The rear cover portion can also house a charger holster 126 as explained further below. This embodiment of the EVSE 105 may also include an optical port 120 as described above.

In the EVSE 105 (without inclusion of a cable holder) as shown in FIGS. 12-16, a top surface 140 of a front cover portion 164 of a housing 112 can have a louver 245 that extends around the rear (or upper) portion of the slanted top surface 140. The louver 245 can have a triangular cross-section with an angled top 246 that forms a peak. The sides of the louver 245 that converge to form the peak 246 can be sloped to divert moisture, such as rain or condensation away from a parting line 176 between the front cover portion 164 and the rear cover portion 166 around the hinge 162. The peak 246 can form the upper most part of the top surface 140 and is above the lower end 148 of the top surface. For example, the sloped side of the louver 245 facing the top surface 140 can direct or divert any moisture build up on the top surface 140 away from the parting line 176 between the front cover portion 164 and the rear cover portion 166 around the top surface 140 and down toward the lower end 148 of the top surface. Similarly, the front cover portion 164 can have side louvers 242 that can be extend around the edges of the front cover portion 164 that extend around the front cover portion 164 that contact the rear cover portion 166 to form the parting line 176. The louver 242 overhangs the edges of the rear cover portion 166 to direct moisture away from the parting line 176. The exact cross-section shape of louver 245 and the louver 242 can vary. Thus, the exact cross-section shape of the louver 245 and the louver 242 can be a design choice.

As shown in FIG. 16, the hinge 162 can comprise a front cover hinge portion 162A of the front cover portion 164 that can be aligned between two rear cover hinge portions 162B on the rear cover portion 166. Each of the hinge portions 162A, 162B have rod insertion apertures therethrough. Once the front cover hinge portion 162A of the front cover portion 164 and the two rear cover hinge portions 162B of the rear cover portion 166 are aligned, a hinge rod 162C can be inserted through the aligned rod insertion apertures and end caps 162D can be secured to either end of the hinge rod 162C to secure the rod 162C in place.

Referring to FIG. 23, a linkage 165, for example, a prop arm, may be rotatably coupled to the front cover portion 164. During normal operation, while the front cover portion 164 pivots about the hinge 162, the rear cover portion 166 remains stationary. When the front cover portion 164 is raised to rotate about the hinge 162, the prop arm 165 can be lowered and rest against a portion of the rear cover portion 166 to hold the front cover portion 164 open during servicing. When the front cover portion 164 is to be closed, the prop arm 165 can be rotated back to a storage position and held by a linkage receiver 165A. By having the front cover portion 164 hinged to the rear cover portion 166 in a clamshell fashion, the portions of the housings 112 stay connected.

### Modular Charge Coupler Holster

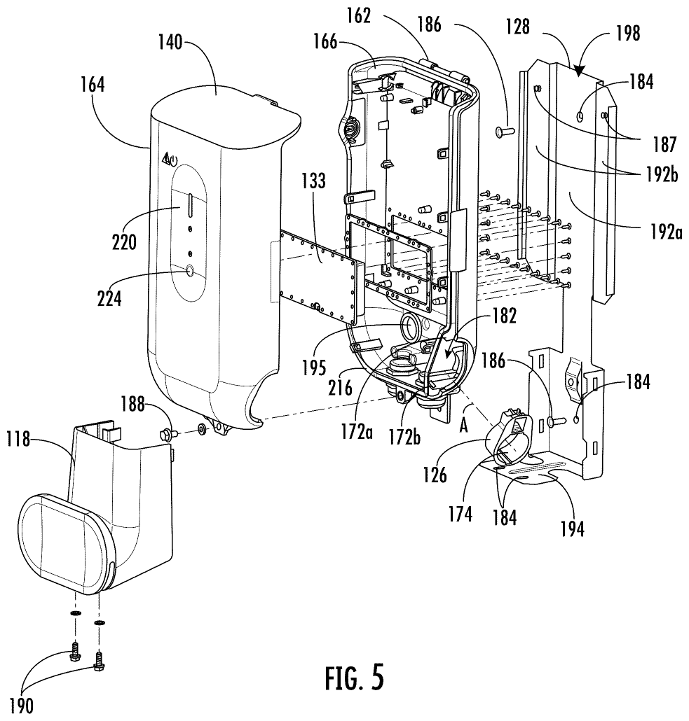

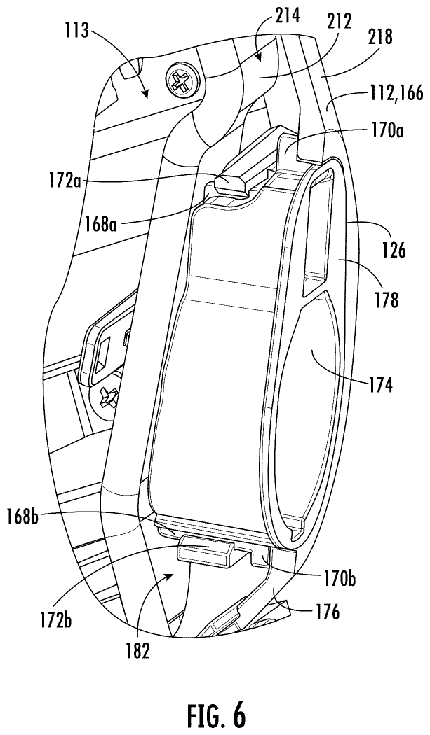

FIGS. 5-6 (amongst others) illustrate a charge coupler holster 126, which is formed as a separate piece from the housing 112 (e.g., the charge coupler holster 126 is not monolithic with the housing 112). Advantageously, forming the charge coupler holster 126 as a separate piece allows the EVSE 105 to be easily manufactured to holster different types of charge couplers 108 (such as those listed herein, others not listed herein, and future charge connector arrangements) without retooling anything other than the charge coupler holster 126. In other words, the housing 112 and other components of the EVSE 105 need not be retooled in order to provide a new version of the EVSE 105 accommodating a different type of charge coupler and holster therefor. As standards for charging electric vehicles change, this feature is particularly advantageous to reduce redesign costs, retooling costs, etc.

The housing 112 is configured to mate with the charge coupler holster 126, e.g., during the manufacturing process. Any suitable mating arrangement to securely couple the charge coupler holster 126 to the housing 112 may be employed. For example, the charge coupler holster 126 may be pressed into the housing 112. In the illustrated example, the charge coupler holster 126 includes a first ridge 168a (which may also be referred to as a wing snap) and a first stop 170a both formed monolithically with the charge coupler holster 126. In the illustrated example, a second ridge 168b and a second stop 170b are also formed monolithically with the charge coupler holster 126, which work the same way as the first ridge 168a and the first stop 170a and need not be described in detail again. Any number of ridges and tabs, such as one, two, three, four, or more, may be employed. The housing 112 includes a complimentary mating arrangement, which mates with the mating arrangement on the charge coupler holster 126. In the illustrated example, the housing 112 includes a first hook 172a and a second hook 172b formed monolithically therewith in a cantilevered fashion, though any number of hooks may be employed (such as one, two, three, four, or more) and only the first hook 172a will be described as it is understood that the second hook 172b works the same way. It should be understood that the ridges and hooks can be reversed such that the hook(s) 172a is provided on the charge coupler holster 126 and the ridge(s) 168a is provided on the housing 112.

The charge coupler holster 126 is pressed into the housing 112 and over the hook 172a until the ridge 168a snaps over the hook 172a (by interference and/or a small amount of flexion) to secure the charge coupler holster 126 to the housing 112. The stop 170a is configured to engage an inner surface of the housing 112 to inhibit the charge coupler holster 126 from falling out of the housing 112 in a lateral direction (lateral to the direction in which the charge coupler holster 126 was inserted into the housing 112). The stop 170a may simply be a surface of the ridge 168a, or a surface of a separate projection. Other surfaces of the housing 112 and/or other internal components of the EVSE 105 may also act as stops to provide positional constraints on the charge coupler holster 126. In other examples, other suitable types of mating arrangements may be employed, such as one or more fasteners, an adhesive, a welding process, a mechanical fit (such as an interference fit, a keyed fit, a snap fit, etc.), interlocking parts, mounts, couplers, detents, any combination thereof, etc.

In the illustrated example, the first and second hooks 172a, 172b (or any variants thereof) are formed monolithically with the rear cover portion 166; however, the first and second hooks 172a, 172b (or any variants thereof) may be formed monolithically with any portion of the housing 112, such as the front cover portion 164. Advantageously, forming the first and second hooks 172a, 172b with the rear cover portion 166 means that the charge coupler 108 can remain holstered while a service technician opens the front cover portion 164. The charge coupler holster 126 is disposed along a parting line 176 (FIG. 3) between the front cover portion 164 and the rear cover portion 166.

The first and second ridges 168a, 168b may be disposed along a midline of the charge coupler holster 126 (as illustrated) or located in any other suitable positions. The first and second stops 170a, 170b may be disposed along the midline (as illustrated) or located in any other suitable positions, the same as or independent from the positions of the first and second ridges 168a, 168b. In the illustrated example, the first ridge 168a is colinear with the first stop 170a (and likewise with the second ridge 168b and the second stop 170b), though the ridge and stop need not be colinear in other implementations.

The charge coupler holster 126 also defines a faceplate 178 formed monolithically therewith. The faceplate 178 provides an external surface flush with the housing 112 to generally match the contours of the housing 112. In the illustrated example, the faceplate 178 is generally planar (meaning the faceplate 178 front surface, configured to face the user, appears flat to one of ordinary skill in the art using the naked eye and ordinary reasonable judgement). However, in other implementations the surface of the faceplate 178 may have a curve or curves, particularly to match the curvature of the housing 112 to create the appearance of being flush therewith and matching the contours (or flatness) thereof. The faceplate 178 defines an outer perimeter 180 thereof having a shape that matches a shape of a corresponding opening 182 in the housing 112 that receives the faceplate 178 generally flush therewith. The outer perimeter 180 therefore defines an externally visible seam between the charge coupler holster 126 and the housing 112. In the illustrated example, the outer perimeter 180 has a truncated teardrop shape, but may have any suitable shape in other implementations. The corresponding opening 182 in the housing 112 is disposed along the parting line 176.

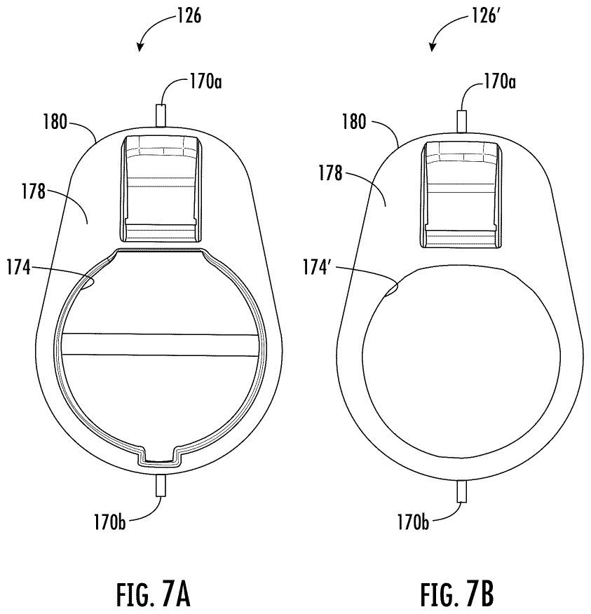

As illustrated in FIGS. 7A-7B, different types of charge coupler holsters 126, 126′ may be provided, each having the same mating arrangement (e.g., the ridges 168a, 168b and stops 170a, 170b and/or other suitable mating arrangement). The different types of charge coupler holsters 126, 126′ differ in the shape of coupler-receiving walls 174, 174′. That is, different shapes of coupler-receiving walls 174, 174′ may be provided to accommodate different types of charge couplers 108 having different shapes. For example, a second charge coupler holster 126′ may be provided to allow a manufacturer or installer to choose which type of charge coupler the EVSE 105 is set up to holster. The second charge coupler holster 126′ has the same mating arrangement as the charge coupler holster 126 but has differently-shaped coupler-receiving walls 174′. The second charge coupler holster 126′ may also have the same outer perimeter 180 (i.e., the same shape as the outer perimeter 180). Two, three, four, or more charge couplers and corresponding charge coupler holsters may be provided.

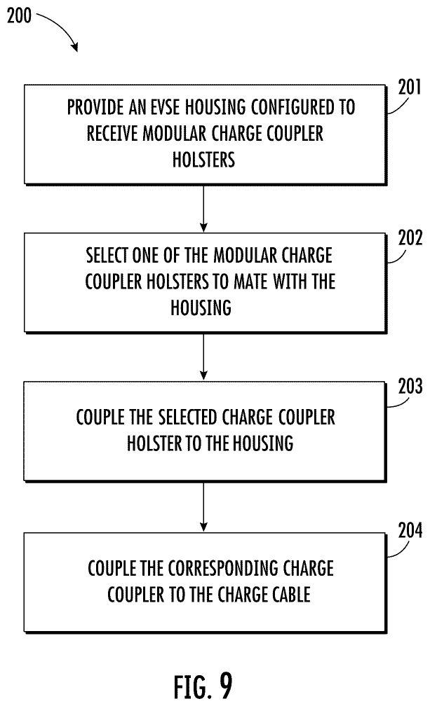

As illustrated in FIG. 9, a method 200 of manufacturing the EVSE 105 may include, at step 201, providing an EVSE housing 112 configured to receive a modular charge coupler holster 126 selectable from a plurality of charge coupler holsters 126, 126′. Each of the plurality of charge coupler holsters 126, 126′ has the same mating arrangement as the others. The mating arrangement of each of the plurality of charge coupler holsters 126, 126′ is configured for mating with a complimentary mating arrangement of the housing 112. Each of the plurality of charge coupler holsters 126, 126′ has the same faceplate outer perimeter shape as the others. At step 202, selecting one of the plurality of charge coupler holsters to mate with the housing 112. Step 202 may also include selecting one of a plurality of charge couplers 108 (e.g., SAE J1772, NACS, etc.) to couple to the charge cable 106. It is understood that the selected charge coupler holster corresponds to the type of charge coupler that will be employed with the EVSE 105 being manufactured. At step 203, coupling the selected one of the plurality of charge coupler holsters to the housing 112. At step 204, the corresponding type of charge coupler 108 is installed on the charge cable 106 (to correspond with the selected charge coupler holster) of the EVSE 105. Although illustrated as occurring sequentially, some of the steps included in the method 200 may be performed in parallel, and some may be performed in a different order than illustrated. Furthermore, it should be understood that additional intermediary steps are also possible in the method 200, some of which are described in this and other paragraphs of the present disclosure.

The charge coupler holster 126 is fixed relative to the housing 112 during use in the field. The fixed implementation improves product reliability, making it less susceptible to breakage with repeated use. The charge coupler holster 126 is a purposeful modular implementation that can accommodate a variety of current and future adaptations such as the North American Charging Standard (NACS) as well as Combined Charging System implementations and others.

### Side-Mounted Charge Handle and Angle of Entry

FIG. 2 illustrates the charge coupler 108 holstered in the EVSE 105. The charge coupler holster 126 is configured to receive the charge coupler 108 from the side (e.g., from a side orthogonal to the vertical mounting plane 156). The charge coupler holster 126 is also configured to receive the charge coupler 108 at an angle of entry E, as illustrated in FIG. 2. The angle of entry E is defined by a receiving axis A relative to the horizontal reference plane 124 (and equally relative to any reference plane 124′ that is parallel to the horizontal reference plane 124). The receiving axis A is defined by the coupler-receiving walls 174 of the charge coupler holster 126 and is the angle at which the charge coupler 108 is received in the charge coupler holster 126. In the illustrated implementation, the angle of entry E is about 22.5 degrees (with “about” meaning+/−2 degrees). Generally, the angle of entry E may range from 20° to 25°, from 15° to 30°, from 10° to 35°, from 20° to 30°, from 20° to 35°, etc. Advantageously, the angle of entry E inhibits moisture from accumulating in the holster 126 where the charge coupler 108 is stowed. Moisture (e.g., condensation) in the holster 126 is able to drain out due to gravity along the coupler-receiving walls 174 because the angle of entry E promotes runoff. The angle of entry E also inhibits moisture, such as rain, from entering the charge coupler holster 126. The housing 112 around the charge coupler holster 126 is angled to compliment the angle of entry E, i.e., angled at 90 degrees minus the angle of entry E, wherein the angle is measured between the slope of the housing 112 and the horizontal reference plane 124 when mounted. In such embodiments, the receiving axis can be about perpendicular to a plane parallel to the slope of the housing 112 around the charger coupler holster 126.

Positioning the fixed charge coupler holster 126 to either side of the EVSE 105 reduces the overall envelope. That is, the charge coupler 108, when seated into the charge coupler holster 126 that is positioned to one side, reduces the level of protrusion the EVSE 105 projects horizontally from the vertical mounting plane 156 (e.g., from the vertical support surface to which the EVSE 105 is mounted). This approach reduces the overall protrusion from the mounting surface when installed, particularly when the charge coupler 108 is in its stowed position, and thus protects the charge coupler 108 from being bumped (e.g., by a person walking past) and from other unintended impacts.

### Cable Stowage

The cable holder 118 is coupled to the mounting bracket 128 and configured to support the charge cable 106 to stow the charge cable 106 (as illustrated in FIG. 2). The cable holder 118 may have any suitable shape or configuration. In the illustrated example, the cable holder 118 has a generally J-shaped profile (see FIG. 3) defining a hook, such as a J-hook. “Generally J-shaped profile” means having a J- or approximately J-shaped configuration as viewed from at least one side in which a nadir region 135 of the “J” is configured for supporting the cable. In other examples, the cable holder 118 defines a recess 135 (which may also be referred to as the nadir region 135 in the more specific example above) configured to receive the charge cable 106 therein.

The cable holder 118 includes a hook portion 136 configured to inhibit the charge cable 106 from slipping off the cable holder 118 while coiled therearound. The hook portion 136 may have a front-facing surface 137. The front-facing surface 137 may accommodate branding, logos, or other indicia, and may be referred to as a billboard. The front-facing surface 137 may have a racetrack-like shape, or pill-shape, defined by two opposing generally parallel linear edges 138a, 138b and two opposing generally curved edges 139a, 139b. The two opposing curved edges 139a, 139b may each (individually) have any convex curved shape (convex with respect to the external environment of the EVSE 105). In the illustrated implementation, the two opposing curved edges 139a, 139b may each (individually) be defined by an arc, or more specifically a semi-circle. In other implementations, the two opposing curved edges 139a, 139b may each have a semi-oval shape. The two opposing curved edges 139a, 139b are mirror images of each other. The two opposing generally parallel linear edges 138a, 138b are also mirror images of each other. The front-facing surface 137 may have a slightly convex curvature in the illustrated example. In other examples, the front-facing surface 137 may be generally planar.

### Mounting Bracket

FIG. 3 illustrates the mounting bracket 128 configured to be coupled to a wall, post, or other support structure that is generally coplanar with the vertical mounting plane 156. As best illustrated in FIG. 5, the mounting bracket 128 includes one or more mounting apertures 184. Any suitable number of mounting apertures 184 may be employed, such as one, two, three, four, or more. Each mounting aperture 184 is configured to receive a fastener 186 to secure the mounting bracket 128 to the wall, post, or other support structure. Some or all of the mounting aperture(s) 184 may be configured as a keyed slot in some implementations. The rear cover portion 166 is removably coupleable to the mounting bracket 128, e.g., directly to the mounting bracket 128. One or more fasteners 187, or any other suitable means, may be employed to secure the rear cover portion 166 to the mounting bracket 128. For example, in some embodiments, as shown in FIGS. 16-19, the fasteners 187 (identified in FIG. 5) can be pin standoffs 250 and the rear cover portion 166 of the housing 112 can comprise securement cavities 230 with keyed slots 232 for receiving the pin standoffs 250 as shown in FIG. 19 and explained further below. The front cover portion 164 is movably mounted with respect to the rear cover portion 166 by way of the hinge 162 (as illustrated in FIG. 8). The front cover portion 164 is removably securable to the rear cover portion 166 by way of a fastener 188 as shown in FIG. 5. When the front cover portion 164 is secured to the rear cover portion 166, the front cover portion 164 is inhibited from opening. In other words, the functionality of the hinge 162 is temporarily disabled when the fastener 188 is secured. The hinge 162 and the fastener 188 are disposed opposite each other, e.g., with the hinge 162 being at or proximate the top of the front cover portion 164 and the fastener 188 being couplable at or proximate the bottom of the front cover portion 164. Any suitable types of fasteners 186, 188 may be employed, such as but not limited to threaded fasteners. In some embodiments, the fasteners 188 can be locks or locking fasteners to prevent unauthorized access to the main component cavity 113 in the housing 112 In the illustrated example, each of the EVSE module 130, the AMI module 132, the user interface module 134, and the antenna 122 is coupled to the rear cover portion 166.

Referring back to the embodiment in FIG. 5, the cable holder 118 is also removably coupleable to the mounting bracket 128, e.g., directly to the mounting bracket 128. One or more fasteners 190 (FIG. 5) may be employed, of any suitable type, such as a threaded fastener(s) and can engage the lower mounting apertures 184a. As such, in the illustrated example, the mounting bracket 128 is configured to support the cable holder 118 and therefore at least a significant portion of the weight of the charge cable 106, and the housing 112 (which may be separately mounted directly to the mounting bracket 128) and other EVSE components are relieved of said strain. By having the cable holder 18 and the housing 112 separately mounted to the mounting bracket 128, the strain of the weight of the cable and the associated wear and tear of use can be bored by the mounting bracket 128 and not the housing 112 of the EVSE 105.

The cable holder 118, when mounted to the mounting bracket 128, also acts as an escutcheon by covering, or dressing, the end of the housing 112 from which the inlet power cord 114 and the charge cable 106 project. Thus, the cable holder 118 provides a finished look when coupled to the EVSE 105.

The mounting bracket 128 may have any suitable shape and configuration. The mounting bracket 128 has sufficient rigidity to support the EVSE 105, the charge cable 106, the charge coupler 108, etc. In the illustrated example, the mounting bracket 128 includes a first generally planar portion 192a and a second generally planar portion 194. The first generally planar portion 192a is configured to be mounted to the wall, post, or other support structure. The housing 112 may be coupled to the first generally planar portion 192a. In the illustrated example, the housing 112 may be coupled to the first generally planar portion 192a by way of a third generally planar portion 192b that is stepped from the first generally planar portion 192a and substantially parallel thereto. The cable holder 118 may be coupled to the second generally planar portion 194. The second generally planar portion 194 may be coplanar with or transverse to the first generally planar portion 192a. In the illustrated example, the second generally planar portion 194 is transverse, and more specifically orthogonal (e.g., perpendicular), to the first generally planar portion 192a. The fastener(s) 190 may be oriented transverse, or more specifically perpendicular, to the fastener(s) 186, 188. In the illustrated example, the second generally planar portion 194 is transverse, or more specifically perpendicular, to the first generally planar portion 192a in order to project from the wall to provide a larger support area for receiving and distributing the force of the charge cable 106 coiled thereon. The mounting bracket 128 may be made of any suitable rigid material, such as metal, to provide strength and rigidity for supporting the EVSE 105 and the corresponding charge cable 106.

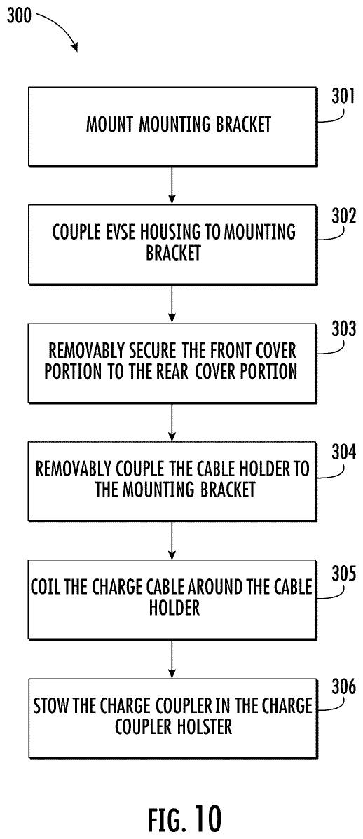

FIG. 10 illustrates a method 300 of installing the EVSE 105 in the field. Reference is also made to the exploded view of the EVSE 105 shown in FIG. 5. Although illustrated as occurring sequentially, some of the steps included in the method 300 may be performed in parallel, and some may be performed in a different order than illustrated. Furthermore, it should be understood that additional intermediary steps are also possible in the method 300, some of which are described in this and other paragraphs of the present disclosure.

At step 301, the mounting bracket 128 is mounted to a suitable wall, post, or other support structure. Any suitable fastener or mounting mechanism may be employed. In the illustrated example (see FIG. 5), the fastener(s) 186 are used to secure the mounting bracket 128. At step 302, the EVSE 105 is removably coupled to the mounting bracket 128. In the illustrated example, the rear cover portion 166 is secured to the mounting bracket 128 and the front cover portion 164 is movably coupled to the rear cover portion 166. For example, the rear cover portion 166 may be removably coupled to the mounting bracket 128 by way of the one or more fasteners 187, 188. For example, the rear cover portion 166 may be coupled to the third generally planar portion 192b. At step 303, the front cover portion 164 may be removably secured to the rear cover portion 166, e.g., by way of the fastener(s) 188. Removably securing the front cover portion 164 inhibits the front cover portion 164 from swinging open about the hinge 162. At step 304, the cable holder 118 may be removably coupled to the mounting bracket 128. For example, the cable holder 118 may be coupled to the mounting bracket 128 by way of the one or more fasteners 190. For example, the cable holder 118 may be coupled to the second generally planar portion 194. For example, the cable holder 118 may be slid over the second generally planar portion 194. For example, the one or more fasteners 190 may be oriented transverse, or more specifically perpendicular, to the fastener(s) 186 and/or the fastener(s) 188. At step 305, the charge cable 106 may be coiled around the cable holder 118. At step 306, the charge coupler 108 may be stowed in the charge coupler holster 126.

Thus, the mounting bracket 128 provides structural support for the EVSE 105, the charge cable 106, and the charge coupler 108 while simultaneously providing a reliable mounting scheme that speeds installation in the field. The cable holder 118 hooks over the mounting bracket 128 to allow for one-handed installation. The cable holder 118 acts as a landing zone for the coiled charge cable 106 and protects the upper-most cables as they enter the housing 112.

The mounting bracket 128 also doubles as a heat-sink extension configured to dissipate heat from the EVSE 105. The EVSE 105 includes a heat sink 133 (FIG. 5) that, when the EVSE 105 is mounted to the mounting bracket 128, is in thermal communication with the mounting bracket 128. The mounting bracket 128 also defines an air channel 198 that allows air to flow across the heat sink 133 and out the top or bottom of the mounting bracket 128. The mounting bracket 128 placement helps dissipate more heat from the heat sink 133.

Referring to the embodiments shown in FIGS. 16-19, once a mounting bracket, such as mounting bracket 128A (or mounting bracket 128 in FIG. 5) is secured to a mounting post, wall or other support structure, the housing 112 of the EVSE 105 can be easily secured to the mounting bracket 128A. The pin standoffs 250 of the mounting bracket 128A can be inserted into the keyed slots 232 of the walled securement cavities 230 on the rear cover portion 166 of the housing 112. The housing 112 of the EVSE 105 shown in FIGS. 12-19 can stably hang from the pin standoffs 250 of the mounting bracket 128A. Once the housing 112 is placed on the pin standoffs 250 of the mounting bracket 128A, a securement tab, or flange, 234 that extends from the rear cover portion 166 of the housing 112 and having a securement aperture 236 therein aligns with a mounting landing 252 on the mounting bracket 128A and having a securement aperture 254 therein such that the securement aperture 236 in the securement tab 234 aligns with the securement aperture 254 in the mounting landing 252. A fastener (not shown) can then be inserted into the securement aperture 236 of the securement tab 234 and the securement aperture 254 of the mounting landing 252 to secure the housing 112 to the mounting bracket 128A. Through the use of pin standoffs and the keyed slots, the housing 112 of the EVSE 105 can be easily secured to the mounting bracket 128A with the use of a single fastener insertable through the securement aperture 236 of the securement tab 234 and the securement aperture 254 of the mounting landing 252. This fastener can be a lock or locking fastener to prevent unauthorized removal of the housing 112 of the EVSE 105 from the mounting bracket 128A.

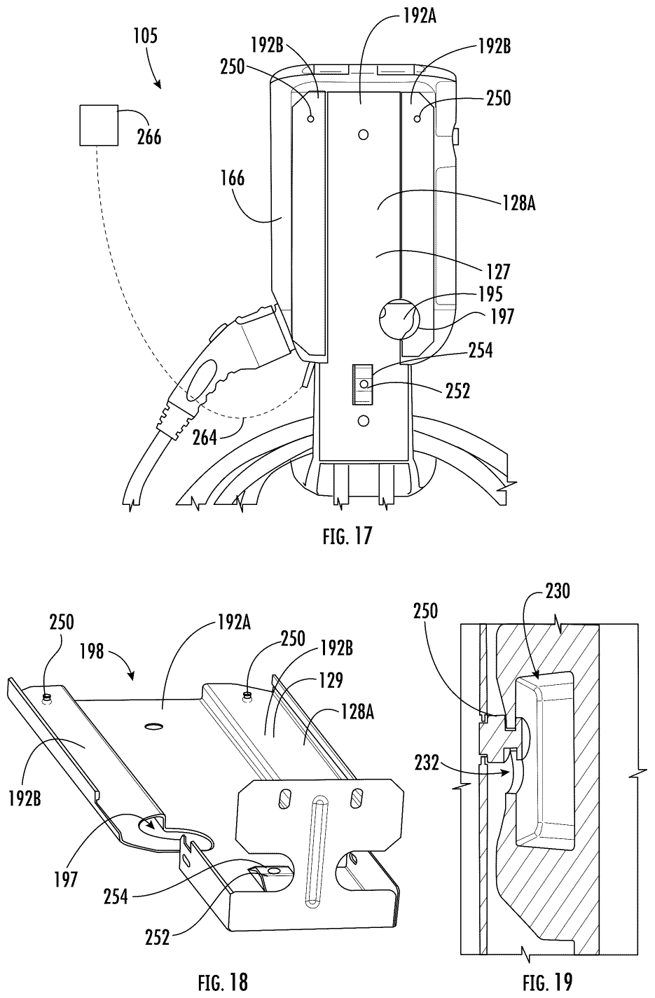

Like the mounting bracket 128 shown in FIG. 5, the mounting bracket 128A in FIGS. 17 and 18 can includes a first generally planar portion 192a configured to be mounted to the wall, post, or other support structure and a second generally planar portion for attachment of a cable holder. The housing 112 may be coupled to the mounting bracket 128A on or adjacent the first generally planar portion 192a, for example, on a mounting surface 129. In the illustrated example, the housing 112 may be coupled to a third generally planar portion 192b that is stepped from the first generally planar portion 192a and substantially parallel thereto. This stepped configuration of the first generally planar portion 192a and the third generally planar portion 192b create an air channel 198 that allows air to flow across the heat sink 133 and out the top or bottom of the mounting bracket 128. The mounting bracket 128A placement can facilitate dissipation of more heat from the heat sink 133.

As stated above, the inlet power cord 114 and the charge cable 106 can be connected to the EVSE 105 through a power cord connector 114A and a charge cable connector 106A, respectively, as shown in FIGS. 15 and 16. In other embodiments, the inlet power cord 114 and the charge cable 106 can be connected at other locations as needed or desired. For example, a rear portion of the rear cover portion 166 of the housing 112 can include a punch-out 195 that permits the connection of the inlet power cord 114 from the rear of the housing 112. In such embodiments that use the mounting bracket 128A, the mounting bracket 128A can have a connection aperture that can align with the punch-out 195 in the rear of the rear cover portion 166 of the housing 112. In this manner, the EVSE 105 can accommodate

### Air-Gapped Cavity for External Coupler

FIG. 8 illustrates the EVSE 105 including an internal wall 212. The internal wall 212 is enclosed by the housing 112 and is therefore internal to the housing 112. The housing 112 provides a barrier to protect the internal wall 212 from the external environment 115. The internal wall 212 may be formed monolithically with the housing 112 or may be formed as a separate piece that is coupled to the housing 112. The internal wall 212 may be formed monolithically with any portion of the housing 112 or formed separately from and coupled to any portion of the housing 112. In the illustrate example, the internal wall 212 is formed monolithically with the rear cover portion 166 of the housing 112. In other examples, the internal wall 212 may be formed monolithically, or formed separately and coupled to, the front cover portion 164 of the housing 112. The internal wall 212 divides an interior of the housing 112 into an internal cavity 214 on one side of the internal wall 212 and the main component cavity 113 on an opposite side of the internal wall 212. The internal cavity 214 is disposed outside of the main component cavity 113.

A seal 216 may be disposed on the housing 112 for weatherproofing the main component cavity 113. The seal 216 may be formed from any suitable material. The seal 216 may be formed from a flexible material. The seal 216 may be formed from an elastomeric material. The seal 216 may circumnavigate main component cavity 113 all the way around the main component cavity 113. For example, the seal 216 can be a gasket. Thus, the seal 216 is continuous around the main component cavity 113. The seal 216 may be disposed between the front cover portion 164 and the rear cover portion 166. In the illustrated example, the seal 216 may be disposed, at least in part, along the internal wall 212 to seal a portion of the clamshell joint that is defined between the internal wall 212 and the front cover portion 164. In other examples, the seal 216 may be disposed in other suitable locations. While the internal cavity 214 need not be sealed using a weatherproofing seal all the way therearound, it is understood that the internal cavity 214 is still internal to the external surface 116 of the housing 112 and is therefore protected from the external environment 115 to at least a substantial degree. The portion of the housing 112 that cooperates with the internal wall 212 to define the internal cavity 214 may be referred to as a fairing 218. The fairing 218 provides a portion of the external surface 116 without disruption to the overall external appearance thereof.

The antenna 122, e.g., for AMI communication, may be disposed in the internal cavity 214. Since the internal cavity 214 is external to the main component cavity 113, the antenna 122 has an air-gapped separation from an antenna coupler, or external coupler, 123 that can also be in the internal cavity 214 to protect components in the main component cavity 113 by the housing 112 of the EVSE 105. The antenna 122 may communicate over the AMI network via, in some examples, radio frequency (RF), RF mesh, cellular power line carrier, ethernet, and/or other similar long-distance communication mediums. The antenna 122 may be configured for bi-directional communication over the AMI network. The antenna 122 may be operatively coupled to the AMI module 132 disposed in the main component cavity 113. Alternatively, as described below, the internal antenna 122 can be disposed on the internal wall 212 in the main component cavity 113 external to the internal cavity 214.

In some implementations, the internal cavity 214 may be configured to receive the charge coupler holster 126. The charge coupler holster 126 may be received in the internal cavity 214. The charge coupler holster 126 may be received below the antenna 122, or spaced from the antenna 122 in any direction. Advantageously, the modularity of the charge coupler holster 126 is improved by receiving the charge coupler holster 126 in a part of the housing 112 that is already separate from the main component cavity 113. This reduces potential interference between installation the modular charge coupler holster 126 with the installation of the electrical components in the main component cavity 113, and simplifies the weatherproofing seal 216.

Thus, the antenna 122 is disposed in a dedicated inner cavity, the internal cavity 214, which is internal to the external surface 116 but external to the main component cavity 113. The antenna coupler 123 may also be disposed in the internal cavity 214. This feature is particularly advantageous where installations require an external antenna for reliable AMI communication. This approach keeps the external air-gapped antenna coupling protected while maintaining a good weatherproof seal for the internal electronics. This air-gapped implementation reduces shock risk and eliminates the need for a galvanic isolation circuit, if the antenna ground is referenced at a potential much greater than zero volts.

The antenna 122 may be coupled directly to the internal wall 212, which may act as a mounting surface. The antenna coupler 123, or external coupler, may be coupled directly to the internal wall 212. The antenna 122 is the physical component that transmits and receives airborne signals. The antenna 122 has to be tuned to certain frequencies to detect them. However, it may be desirable for the antenna 122 to be able to detect multiple frequencies. As such, the antenna coupler 123 is a device that may change the frequency at which the antenna 122 is tuned, e.g., by changing the impedance.

Other antenna configuration can be used within the other EVSE embodiments. For example, referring to FIGS. 20-22, a slightly different antenna configuration is provided in the embodiment of the EVSE 105 shown therein that provides an air-gapped separation. An internal antenna 260 can be positioned on an internal wall 212 within the main cavity 113 within the rear cover portion 166 of the housing 112. The internal antenna 260 can be operatively coupled to an AMI module (as shown in FIG. 8 and referenced by 132) or other network interface card (NIC). In installations of the EVSE 105 that result in poor radio or signal communication, an inductive external coupler 262 can be positioned external of the main component cavity 113 of the housing 112. For example, the inductive external coupler 262 can be positioned on the internal wall 212 of the front cover portion 164 of the housing 112 in the internal cavity 214 outside of the main cavity 113. The inductive external coupler 262 can be aligned in proximity to the internal antenna 260. The internal antenna 260 and the external coupler 262 can be further separated by the seal 216, such as a gasket, for example, a NEMA gasket. Thus, in this embodiment, the internal antenna 260 and the external coupler 262 are separated by the internal wall 212, which can be a plastic material, and the seal 216 in such a design. In other embodiments, the internal antenna 260 and the external coupler 262 can be separated by air, space, or other material, such as a plastic, that limits interference of the transmission of signals between the internal antenna 260 and the external coupler 262 to provide an air-gapped separation.

The internal antenna 260 and the external coupler 262 can act as conductors. These two conductors are said to be inductively coupled when they are configured in a way such that change in current through one component induces a voltage across the ends of the other component through electromagnetic induction. A changing current through the first component creates a changing magnetic field around it. The changing magnetic field induces an electromotive force (EMF) voltage in the second component. The amount of inductive coupling between two conductors is measured by their mutual inductance. As above the external coupler 260 may change the frequency at which the antenna 260 is tuned, e.g., by changing the impedance. The arrangement of the internal antenna 260 and the external coupler 262 to provide an air-gapped separation promotes personnel safety and avoids possible shock hazards.

The external coupler 262 can be operatively coupled to an external antenna 266 as shown in FIGS. 17 and 21 to increase the signal strength depending on the placement of the EVSE 105. Such an external antenna 266 can also be used with the EVSE 105 embodiment shown in FIG. 8. For example, the external coupler 262 can be connected through one or more transmission lines, or wires, 264 to the external antenna 266. For example, the transmission lines 264 can be a coaxial cable, or the like. As shown in FIGS. 17 and 21, the connection between the external coupler 262 and the external antenna 266 can be made through the one or more transmission lines passing through an antenna passage 167 in the rear cover portion 166 of the housing 112. The external antenna 266 can then be mounted at some distance from the EVSE 105 where stronger communication signals can be received.

### Sub-Flush Actuator(s)

FIG. 11 illustrates a cross-section through the EVSE 105. The front cover portion 164 includes a sub-flush surface 220 that is recessed relative to the immediately-surrounding external surface 116 (which may also be referred to herein as at least one planar external surface portion). The sub-flush surface 220 includes a user interface 222 (FIG. 2). The user interface 222 may be operatively coupled to, or a part of, the user interface module 134. The user interface 222 may include one or more actuators 224 configured to be actuatable by touch, e.g., configured as tactile buttons and/or touch screen display configured to receive user inputs and/or the like. The user interface 222 may additionally or alternatively include one or more displays, such as lights 223. The one or more actuators 224 and/or lights 223 are sub-flush with respect to the rest of the external surface 116. In the illustrated example, the one or more actuators 224 are recessed from the immediately-surrounding external surface 116 (which is generally planar immediately around the sub-flush surface 220) by a distance D of about 0.1 inches (with “about” meaning+/−0.02 inches). In other examples, the one or more actuators 224 are recessed from the immediately-surrounding external surface 116 by a distance D of 0.05 inches to 0.3 inches, or of 0.05 inches to 0.15 inches. In other examples, the one or more actuators 224 are recessed from the immediately-surrounding external surface 116 by a distance D of 0.1 inches to 0.2 inches. In other examples, the one or more actuators 224 are recessed from the immediately-surrounding external surface 116 by a distance D of 0.1 inches to 0.3 inches.

The sub-flush surface 220 is inset relative to the outermost planar surface defined by the external surface 116 of the housing 112 facing away from the mounting surface (e.g., see the mounting plane 156 in FIG. 3) and may be generally parallel to the mounting surface (e.g., the mounting plane 156).

The sub-flush surface 220 may have a generally racetrack-like shape, or pill-shape, best illustrated in FIG. 2, defined by two opposing generally parallel linear edges 226a, 226b and two opposing curved edges 228a, 228b. The two opposing curved edges 228a, 228b may each (individually) have any convex curved shape (convex with respect to the external environment of the EVSE 105). In the illustrated implementation, the two opposing curved edges 228a, 228b may each (individually) be defined by an arc, or more specifically a semi-circle. In other implementations, the two opposing curved edges 228a, 228b may each have a semi-oval shape. The two opposing curved edges 228a, 228b are mirror images of each other. The two opposing generally parallel linear edges 226a, 226b are also mirror images of each other.

The one or more actuators 224 may allow a user of the EVSE 105 to provide an input to the EVSE 105. For example, the one or more actuators 224 may provide an input actuator that allows a user to enable an “opt-out” setting of the EVSE 105. When the opt-out setting (or Override Demand Response Events setting) is enabled, the EVSE 105 ignores commands from the utility to reduce or pause the charging current advertised to the electric vehicle 110. For example, the utility may want to reduce or pause electric vehicle charging during elevated grid utilization. Choosing the opt-out setting allows charging of the electric vehicle to continue. In some implementations, additional actuators may be provided on the user interface 222 to allow a user to provide additional inputs to the EVSE 105.

A sub-flush user interface 222 inhibits unwanted actuator presses when the user brushes against the front of the housing 112. The actuator 224 may include an override actuator (or opt-out actuator), amongst others.

The lights 223 may be configured such that if green is displayed, charging is operational. The lights 223 may be configured such that if red is displayed, there is a fault. Alternative colors may be employed to replace green and red so long as the colors are different from each other. Advantageously with this configuration, long distance legibility is provided because the user only needs to be able to see which of the two colors is displayed to know whether the EVSE 105 is charging properly and does not need to read letters or discern indicia. Other indica, such as wording “operable” and “inoperable,” however, can be displayed in the user interface 222 or illuminated by the lights 223, if preferred by the owner.

As shown in the embodiment of the EVSE 105 shown in FIGS. 20-23, the user interface module 134 can be positioned in the front cover portion 164 of the housing 122 close to the user interface 222 in the sub-flush surface 220. The user interface module 134 can be operatively coupled to the circuit module 130 in the main component cavity portion of the rear cover portion 166 of the housing 112. For example, a transmission line 134A can be connected to the circuit module 230 by a receiver and plug. The transmission line 134A can have a connection plug 134B that can operatively connect to a receiver 134C on the user interface module 134 to permit operative communications between the modules 130, 134. Alternatively, other wired or wireless communication configurations can be used between the user interface module 134 and the circuit module 130.

The user interface module 134 shown in FIGS. 20-23 can be operatively coupled to an actuator module 244A connect to the actuator 224 shown in FIG. 15. For example, a transmission line 225 can be connected to the user interface module 134 and the actuator module 244A.

### Optical Port Location

FIG. 2 illustrates an optical port 120. The optical port 120 allows an operator or technician of the EVSE 105 to access software and memory associated with the EVSE 105. For example, an external device may connect to the EVSE 105 via a wireless or physical connection using the optical port 120. In some implementations, the optical port 120 may be integrated into the rear cover portion 166. As one example, the optical port 120 may be accessed via a USB device that magnetically connects to the optical port 120. As another example, an external device magnetically connects to the optical port 120 and communicates wirelessly with the EVSE 105, allowing bidirectional communication between the EVSE 105 and, for example, a computer used by a utility technician. In some embodiments, the optical port 120 is configured as a D-ring. The optical port 120 allows the utility to perform operations on the integrated internally situated revenue grade meter. Possible meter operations that can be performed via the optical port 120 may include but are not limited to reset, read, write, configure, calibrate, update, etc.

As illustrated in FIG. 5, the optical port 120 is coupled directly to the rear cover portion 166. The optical port 120 may be disposed on an opposite side of the rear cover portion 166 relative to the antenna 122. The optical port 120 may be air-gapped from the main component cavity 113 in some implementations. Similarly, the optical port 120 can be provided in the embodiment shown in FIGS. 12-23.

Thus, the application provides, among other things, an electric vehicle supply equipment. Various features and advantages of the application are set forth in the following aspects.

These and other modifications and variations to the present subject matter may be practiced by those of ordinary skill in the art, without departing from the spirit and scope of the present subject matter, which is more particularly set forth herein above and any appending claims. In addition, it should be understood the aspects of the various embodiments may be interchanged either in whole or in part. Furthermore, those of ordinary skill in the art will appreciate that the foregoing description is by way of example only, and is not intended to limit the present subject matter.

What is claimed is:

1. An electric vehicle supply equipment (EVSE) comprising:
a housing;
a charge cable;
a charge coupler coupled to the charge cable and configured to supply power to an electric vehicle;
a charge coupler holster configured to receive the charge coupler for storage, wherein the charge coupler holster is formed as a separate piece from the housing and configured to be coupled to the housing to provide modularity.

2. The EVSE of claim 1, wherein the charge coupler holster includes a mating arrangement, and the housing includes a complimentary mating arrangement, the mating arrangement being configured to mate with the complimentary mating arrangement to secure the charge coupler holster to the housing.

3. The EVSE of claim 2, wherein the mating arrangement is formed monolithically with the charge coupler holster, and the complimentary mating arrangement is formed monolithically with the housing.

4. The EVSE of claim 3, wherein the mating arrangement includes one of a ridge or a hook, and the complimentary mating arrangement includes the other of the ridge or the hook.

5. The EVSE of claim 4, wherein the mating arrangement further includes a stop configured to engage the housing to inhibit the charge coupler holster from falling out of the housing in a lateral direction that is lateral to a direction in which the charge coupler holster is insertable into the housing.

6. The EVSE of claim 4, wherein the ridge is disposed along a midline of the charge coupler holster.

7. The EVSE of claim 1, wherein the charge coupler holster includes a faceplate configured to mate flush with the housing.

8. The EVSE of claim 1, wherein the charge coupler holster includes a first ridge and a second ridge formed monolithically with the charge coupler holster, each of the first ridge and the second ridge being disposed along a midline of the charge coupler holster, wherein the housing includes a first hook and a second hook formed monolithically with the housing, wherein the first ridge is configured to mate with the first hook and the second ridge is configured to mate with the second hook to secure the charge coupler holster to the housing.

9. The EVSE of claim 1, wherein the housing is a clamshell-style housing formed from at least two portions, and wherein the charge coupler holster is configured to be received between the at least two portions of the clamshell-style housing.

10. The EVSE of claim 1, wherein the charge coupler is configured to be received in the charge coupler holster from a side of the EVSE.

11. The EVSE of claim 1, wherein the charge coupler holster is configured to receive the charge coupler at an angle of entry, wherein the angle of entry is 10° to 35°.

12. A method of manufacturing an electric vehicle supply equipment (EVSE), the method comprising:
providing an EVSE housing configured to receive a charge coupler holster selectable from a plurality of charge coupler holsters;
selecting one of the plurality of charge coupler holsters to mate with the EVSE housing, coupling the selected one of the plurality of charge coupler holsters to the housing; and
installing a corresponding charge coupler to the EVSE.

13. The method of claim 12, wherein each of the plurality of charge coupler holsters has a different-shaped receptacle from the others, wherein each of the plurality of charge coupler holsters has a mating arrangement that is the same as the others, and wherein the mating arrangement of each of the plurality of charge coupler holsters is configured for mating with a complimentary mating arrangement of the EVSE housing.

14. The method of claim 12, wherein each of the plurality of charge coupler holsters has a faceplate configured to mate flush with the EVSE housing, wherein each of the plurality of charge coupler holsters has a same faceplate outer perimeter shape as the others.

15. The method of claim 12, wherein coupling the selected one of the plurality of charge coupler holsters to the EVSE housing includes snapping a ridge over a hook.

16. An electric vehicle supply equipment (EVSE) comprising:
a mounting bracket configured to be coupled to a mounting surface, the mounting bracket including a first portion and a second portion;
a housing configured to be coupled to the first portion of the mounting bracket;
a charge cable;
a charge coupler coupled to the charge cable and configured to supply power to an electric vehicle; and
a cable holder configured to support the charge cable coiled thereon, wherein the cable holder is configured to be coupled to the second portion of the mounting bracket, the second portion of the mounting bracket being different from the first portion of the mounting bracket to which the housing is couplable.

17. The EVSE of claim 16, wherein the second portion of the mounting bracket extends transversely to the first portion of the mounting bracket.

18. The EVSE of claim 16, wherein the second portion of the mounting bracket extends perpendicularly to the first portion of the mounting bracket.

19. The EVSE of claim 16, wherein the cable holder has a generally J-shaped profile.

20. The EVSE of claim 16, wherein the cable holder is an escutcheon covering an end of the housing from which the charge cable projects.

21. The EVSE of claim 16, wherein the mounting bracket is in thermal communication with a heat sink disposed in the housing such that the mounting bracket is configured to dissipate heat.

22. An electric vehicle supply equipment (EVSE) comprising:
a housing including at least one planar external surface portion and a sub-flush surface recessed from the at least one planar external surface portion, wherein the at least one planar external surface portion immediately surrounds the sub-flush surface;
a charge coupler configured to supply power to an electric vehicle; and
a user interface including at least one actuator disposed in the sub-flush surface.

23. The EVSE of claim 22, wherein the at least one actuator is recessed from the at least one planar external surface portion by a distance of 0.05 inches to 0.3 inches.

24. The EVSE of claim 22, wherein the at least one actuator is configured to control an opt-out setting of the EVSE, wherein the opt-out setting is configured to ignore commands from a utility to reduce the charging current advertised to the electric vehicle.

25. An electric vehicle supply equipment (EVSE) comprising:
a housing defining a main component cavity configured to house at least one circuit board, the housing further defining a separate internal cavity;
a charge coupler configured to supply power to an electric vehicle;
an internal antenna positioned within the housing; and
an external coupler configured to communicate with the internal antenna, the external coupler disposed in the separate internal cavity separate from the main component cavity such that the external coupler has an air-gapped separation from the internal antenna.

26. The EVSE of claim 25, wherein the housing includes an internal wall formed monolithically therewith, the internal wall configured to separate the main component cavity from the separate internal cavity.

27. The EVSE of claim 26, wherein the external coupler is configured to be coupled to the internal wall.

28. The EVSE of claim 25, wherein a weatherproofing seal is disposed around the main component cavity.
